(19) United States
(12) Patent Application Publication
(10) Pub. No.: US 2026/0340191 A1
(43) Pub. Date: Oct. 29, 2026

(54) Technique for Administering a Motor Vehicle in a Fleet Context

(71) Applicant: Bayerische Motoren Werke Aktiengesellschaft, Muenchen (DE)

(72) Inventors: Matthias FINK, Muenchen (DE); Michael FURCHNER, Mering (DE)

(21) Appl. No.: 19/657,626

(22) Filed: Apr. 24, 2026

(30) Foreign Application Priority Data
Apr. 25, 2025 (DE) 10 2025 116 123.2

(51) Int. Cl. G06F 21/62; B60W 50/08; B60W 50/00

(52) U.S. Cl. CPC G06F 21/6281; B60W 50/085; B60W 2050/0083

(57) ABSTRACT

A method for administering a motor vehicle in a fleet context includes detecting a portable fleet management token in the motor vehicle and, in response to the detected presence of the fleet management token, enabling a fleet-related administrative setting in the motor vehicle.

### CROSS REFERENCE TO RELATED APPLICATION

This application claims priority under 35 U.S.C. §119 from German Patent Application No. 10 2025 116 123.2, filed Apr. 25, 2025, the entire disclosure of which is herein expressly incorporated by reference.

### BACKGROUND AND SUMMARY

The invention relates to a technique for administering a motor vehicle in a fleet context, e.g. separating the motor vehicle from a fleet. A corresponding method can be implemented, for example, in a control apparatus for the motor vehicle, e.g. for access control of the vehicle.

It is known that a digital key can be stored on a terminal, for example a smartphone, for instance in a secure memory of the device. Use of the key is based on interfaces between the secure memory and an operating system of the device, and also between the operating system and other applications (“apps”) that are executed on the device.

The “Car Connectivity Consortium” (CCC) thus defines a standard for digital vehicle keys in the form of a technical specification. Corresponding digital keys are increasingly being used in addition or as an alternative to conventional vehicle keys such as key fobs.

In this context, an application or app of a vehicle manufacturer (or of a service provider) may be installed for instance on a terminal and allows access to the vehicle by means of a digital vehicle key held on the device, allows certain vehicle functions to be controlled, etc. Extended possibilities for use also arise from the existence of a backend system for key management, i.e. management or maintenance of the digital vehicle key. Key management links the terminal and the vehicle and allows key sharing and other services.

A digital key or vehicle key can be created for example by pairing a terminal with a vehicle. In a CCC context, this is called an owner pairing method. The prerequisite for this is that a proof of ownership is provided to the vehicle, e.g. by presenting two key fobs, or a setup card and a key fob, in parallel.

A digital key can also be passed or shared from one device to another (“key sharing”), for example from one user to another user (for instance in a private use case), from a backend to a user (for example in a commercial-server-to-user use case), from a user to a backend (by means of so-called “service activation”, as specified by the CCC) or from backend to backend. Corresponding signaling, for example according to the CCC, involves a terminal or multiple terminals, a device manufacturer server, a vehicle manufacturer server and the vehicle, and also possibly a service provider server for server-based key sharing.

A backend that has a key for a vehicle is referred to as an SBOD (“Server Based Owner Device”) or SBFD (“Server Based Friend Device”). An SBOD is a root element of a key sharing tree, and is thus a kind of equivalent to a natural person who has performed owner pairing with their terminal. When a vehicle is integrated into a fleet, an SBOD is provided, with which a rental company or fleet operator can interact for key sharing.

An SBFD, on the other hand, is directly or indirectly shared by an owner (a natural person or a backend). The SBFD is tied to a service provider, which interacts with the SBFD for key sharing. Customers of the service provider may be involved, e.g. for a car sharing service, a workshop, etc. The process of key sharing to the backend is carried out by means of the aforementioned service activation.

An SBxD (SBOD or SBFD) follows the same rules as other digital keys; however, an SBxD cannot usually exercise its rights itself, but can only pass on or hand down these rights to a shared (an assigned), forwarded, derived key, etc.

The creation of an SBFD service by means of service activation is carried out by means of a corresponding (proprietary, vehicle manufacturer-specific) service request. The request is signed with an authorized digital key. Alternatively, it is possible to carry out regular key sharing with a backend of a service provider or vehicle manufacturer in order to create an SBFD (standardized CCC key sharing protocol). SBODs, on the other hand, are created on the basis of a proof of ownership, which is provided, for example, by a fleet operator, which can take place in different ways.

Within the reference system of the digital key, there are therefore already some concepts for handling vehicles; in particular, there are also initial concepts for handling vehicle fleets, i.e., for example, for safely integrating a vehicle into a fleet (cf., in this respect, DE 10 2024 130 382 of the applicant). However, in the context of fleet management, there is a lack of further concepts for administering, managing or maintaining the fleet vehicles.

There is a need for such developed concepts for fleet vehicles, which in particular ensure safe, secure and at the same time convenient and easy handling of management tasks for employees of fleet operators, car dealerships etc. One object on which the present invention is based involves providing a corresponding concept. The invention achieves this object by means of the subjects of the independent claims. Dependent claims describe preferred embodiments.

A first aspect of the present invention relates to a method for (securely) administering a motor vehicle in a fleet context. The method can take place in a control apparatus of a motor vehicle, e.g. for access control, a head unit, an HMI component, etc. (HMI = "Human Machine Interface"). The method comprises detecting a portable fleet management token in the motor vehicle; and, in response to the detected presence of the fleet management token, enabling a fleet-related administrative (e.g. manual) setting or setting option for the or in the motor vehicle.

The fleet management token (which is sometimes referred to herein, for short, as an "FM token" or only as a "token") may be a smart card, a chip card, a memory card, etc.; occasionally, therefore, reference is made herein to a "fleet management card" or "FM card". However, the token can also generally be a hardware token or a physical, portable, manageable, portable, etc. carrier, a carrier medium, a storage medium, etc., wherein, instead of a card format, the token can also have a different form factor, e.g. a USB token or a key fob, a chip (such as in the form of a key fob), etc. It is also contemplated for the HW token to be in the form of an intelligent device, e.g. in the form of a smartphone or comparable mobile device, on which an app, an applet, etc. with appropriate functionality is available.

The token can be detected, for example, using NFC technology (NFC = “Near Field Technology”). In general, however, detection or interaction with an FM token can take place by means of any wireless, contactless and/or short-range technology known as such or developed in the future, including, for example, Bluetooth, BLE ("Bluetooth Low Energy"), UWB ("Ultra-Wide-Band"), Firebird, WLAN ("Wireless LAN"), RFID ("Radio Frequency ID"), iBeacon, etc.

The FM token can be detected, for example, using an NFC write/read device or a pure NFC read device (generally also an "NFC reader"), which can be available as a stand-alone device or in integrated form, e.g. connected to or integrated in e.g. (inside the motor vehicle) a head unit, an HMI, but also generally an access controller, i.e. a read device connected to a locking system, immobilizer, etc.

In some embodiments, the token is detected only inside the vehicle, i.e. when the token is held to an NFC reader in a passenger area, a passenger compartment, or generally on board the vehicle. In some embodiments, however, a vehicle environment can also be understood to mean an external environment of the vehicle, i.e. around the vehicle. In general, the vehicle interior as well as the environment can be defined by a range or a coverage area, detection area, etc. of a particular (NFC) reader or multiple (NFC) readers, by means of which a "presence", localization, positioning, etc. of the FM token is detected.

In some embodiments, the token may carry fleet-related carrier information or ID (generally an identification, identity, identification or identity information, identification or identity number, etc.), i.e. the token is regarded as a (secure) carrier, carrier medium, storage medium for the fleet-related information or ID (also referred to herein as fleet information or "fleet ID” for short). The fleet ID can identify or designate a specific fleet provider such as a vehicle rental company, etc., so that either directly or indirectly, in the technical sense, etc., a set of settings (comprising at least one setting, and, if necessary, with the appropriate setting options) becomes identifiable for a fleet of vehicles, i.e. for those vehicles that have been added to the fleet and have therefore activated a corresponding fleet configuration, are in a corresponding fleet context, etc.

In general, fleet vehicles therefore have at least two separate sets of settings in the vehicle for two configurations, e.g. a fleet configuration on the one hand, and a configuration intended for private users or owners or proprietors of the vehicle, the latter also being referred to herein as a normal, regular or standard configuration. In one embodiment, both or multiple configurations may be held in the vehicle (in which case only one configuration is active at any time). In another embodiment, however, the backend may hold a plurality of configurations and, in the event of a configuration change (e.g. inclusion in the fleet or integration, or removal from the fleet or separation of the vehicle), can reconfigure the vehicle accordingly by transferring a new or current configuration to the vehicle.

In addition to reading carrier information or a fleet ID from the FM token (e.g. for verification), some embodiments comprise resolving or translating the fleet ID in order to be able to determine the relevant set of settings. The resolving can be carried out inside the vehicle or may involve communication or interaction with a backend. In certain embodiments, the resolving comprises a handshake between the FM token and the backend, wherein the handshake takes place or is facilitated via the vehicle.

In some embodiments, there is at least one administrative setting (in a fleet context) for which the setting is enabled, released, uncovered, made available etc. (if necessary only) in response to the verified presence of the FM token, i.e. the setting cannot be called up, selected or chosen, etc. via operating actions, e.g. for a customer of the fleet operator or a private user. In other embodiments, the setting can be called up for customers, private persons, etc., but only via complicated operating actions on an HMI in the vehicle, and the verified presence of the fleet management token in the vehicle leads to easier accessibility or operability, e.g. by opening the setting immediately in response to the presence of the card.

Administering, maintaining, handling, managing the vehicle (in a fleet context) can include at least one operating action, such as choosing or selecting a setting option, adjusting a setting, etc., e.g. selecting, tapping, etc. a button, choosing an offered option, action, operation, etc. by an operator in the vehicle, e.g. on an HMI, a console, a head unit, etc. The operating action can be carried out manually, but can also be carried out by voice control, gestures, facial expressions, etc., or a combination of these.

In some embodiments, the enabling involves enabling access to a menu which comprises at least one interactive setting option for interaction with the motor vehicle. Multiple setting options can be enabled, e.g. in the form of the menu, which allows one or more of the enabled settings, actions, options, etc. to be selected. In certain ones of these embodiments, the menu is opened immediately, i.e. the enabling in response to the verified presence of the fleet management token includes a presentation of the menu. Administration or administrative setting is then carried out, for example, by selecting an option offered by the menu.

Preferred embodiments further comprise an autonomous implementation of the administrative setting made in the motor vehicle, i.e., an implementation of which is initiated or controlled in the vehicle (in charge), i.e. not in a backend. This does not exclude interaction with a backend, i.e. for example sending a request for a fleet-related management operation to the backend.

Preferred embodiments further include a verification of the fleet management token, wherein the enabling is carried out in response to a verified presence of the fleet management token. Verifying the fleet management token can include, for example, a handshake that takes place between the token and the vehicle. A handshake can also take place between a token and a backend, i.e. for example a backend server for fleet management, which is operated by a vehicle manufacturer and/or a fleet operator or provider. In some embodiments, there may be, for example, an instance of a certificate authority (CA) on the token, and the verification may include reading and verifying a corresponding certificate from the FM token.

Some embodiments include, as a further step, in response to a selection of a or the fleet-related administrative setting, renewed detection and/or verification of the fleet management token. Bringing the FM token back into contact with a read device can be required as a confirmatory operating action, e.g. for a critical action or operation, from a security point of view, process point of view, etc.

Some of these or other embodiments comprise, as a further step, in response to a selection of the fleet-related administrative setting, a verification of a presence of a vehicle key (for the motor vehicle) in the motor vehicle, i.e. for example a key fob and/or a setup card.

In some embodiments of this aspect of the invention, the fleet-related administrative setting comprises separating the motor vehicle from a corresponding fleet, i.e. a removal from the fleet, termination of a fleet context for the motor vehicle, etc. Some of these embodiments further include a change or a replacement or a reset of a fleet configuration to a private configuration, i.e., a configuration for private users (owners, proprietors, co-users) of the motor vehicle, that is to say a normal or regular configuration. Some embodiments additionally or alternatively include deletion, e.g. final deletion, of (shared) digital keys for the vehicle, i.e. all digital keys, or all keys in a certain state, i.e. for example all active keys.

Certain embodiments relate to fleet-related administrative setting options for the motor vehicle, which are in particular enabled even without the presence of a vehicle key (including a digital key) in the motor vehicle and thus can be configured. This can be, for example, settings, options, configuration options, etc. that are classified as non-critical and handled accordingly. This can be, for example, a presentation or exhibition mode of the vehicle.

In some embodiments, the fleet management token is registered with a backend (such as a manufacturer backend) and/or tied to a backend (such as of a fleet operator). Additionally or alternatively, the fleet management token may be known to the motor vehicle, e.g. identity information relating to the token may be stored in the motor vehicle.

Another aspect of the present invention relates to use of a portable hardware token as a fleet management token for administering a motor vehicle in a fleet context. The fleet management token is configured to be detected in the motor vehicle, so that the motor vehicle, in response to the (optionally verified) presence of the fleet management token, enables a fleet-related administrative setting in the motor vehicle.

Some embodiments of the fleet management token are configured for use as a second factor for confirming a fleet-related administrative setting to a backend, e.g. for generating a signature.

Yet another aspect of the present invention relates to a control apparatus which is designed to carry out a method described herein for controlling a fleet-related setting for a motor vehicle. The control apparatus may be provided as a stand-alone apparatus in a motor vehicle, or in integrated form or as part of (a comprehensive control apparatus of) access control, control of key management in the vehicle, or a head unit, HMI, or in distributed form.

Yet another aspect of the invention relates to a motor vehicle which has a read device for reading at least one physical carrier or portable hardware token, e.g. an NFC read device on board the motor vehicle, and a control apparatus described herein. The control apparatus can be implemented, for example, as part of an ECU of the motor vehicle.

Yet another aspect of the invention relates to a vehicle fleet having at least one motor vehicle as described herein, and a hardware token configured for use as a fleet management token as described herein. In particular, the same fleet management token can be used for a multiplicity of motor vehicles in a fleet.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates an exemplary embodiment of a system according to the invention,

FIG. 2 illustrates a flowchart of a first exemplary embodiment of a method according to the invention;

FIGS. 3A, 3B and 3C illustrate a flowchart of a second exemplary embodiment of a method according to the invention;

FIG. 4 illustrates a flowchart of a third exemplary embodiment of a method according to the invention;

FIG. 5 illustrates a flowchart of a fourth exemplary embodiment of a method according to the invention; and

FIGS. 6A and 6B illustrate a flowchart of a fifth exemplary embodiment of a method according to the invention.

### DETAILED DESCRIPTION OF THE DRAWINGS

A motor vehicle (or "vehicle” for short) is understood herein to mean in particular a passenger vehicle, a motorcycle, a truck or bus, or a work or utility vehicle such as a delivery truck. The considerations set forth herein apply analogously to a motorcycle, for example, in which case an "interior" may be analogous to a vicinity of the handlebars.

A fleet of vehicles or vehicle fleet as understood herein comprises at least one vehicle, usually a plurality of vehicles, e.g. a small number of vehicles, such as three, five or ten vehicles, or even a large number of vehicles, such as thousands of vehicles. Fleet vehicles can all be of the same (vehicle) type, i.e. for example limousines of a particular manufacturer, a particular series, etc., or can include different vehicles, for example passenger vehicles and/or delivery vehicles of different manufacturers, types, etc.

A hardware token or HW token, in particular a fleet management token, to which reference is made herein, may generally have a carrier structure such as a card, a stick, etc., wherein the structure carries, includes, accommodates, etc. a data memory, chip, etc. (the same applies to other form factors). For example, if the carrier is designed as a memory card, it can be, for example, a plastic card, chip card, smart card, etc. with an integrated circuit (chip), a hardware logic unit, a memory and/or a microprocessor. A memory of the HW token may be designed to store at least one digital certificate for verification purposes and/or signature creation and a fleet ID as described herein.

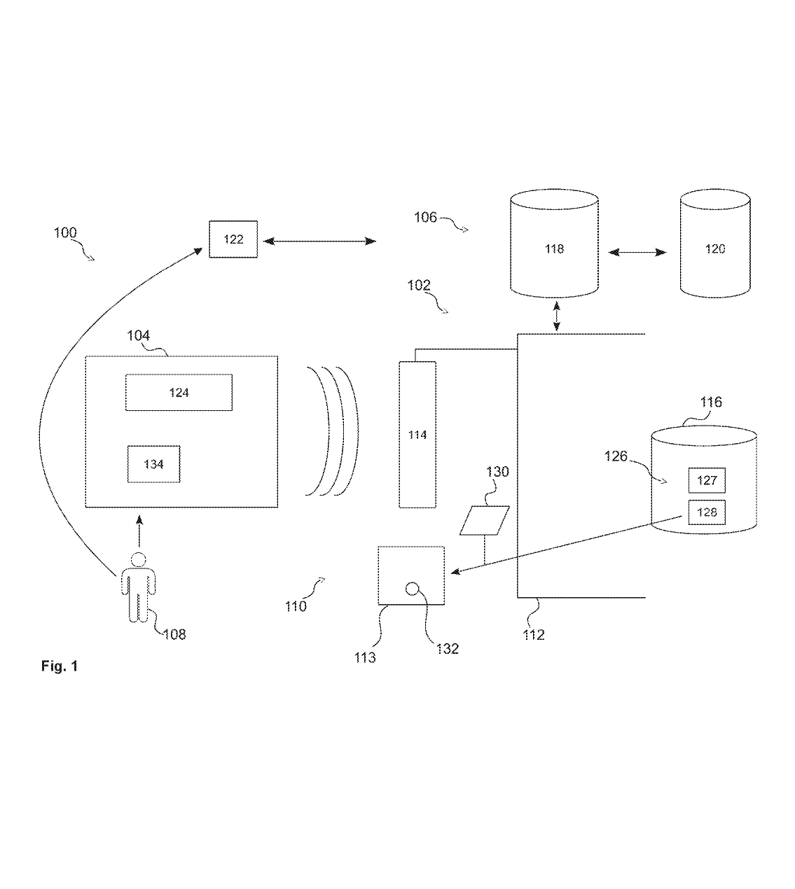

FIG. 1 schematically shows an exemplary embodiment of a system 100 having a motor vehicle 102, a fleet management card 104, a general backend 106, and an operating person 108.

Of the (motor) vehicle 102, only a console 110 and a control apparatus 112 are generally indicated. The console 110 can be provided as a vehicle console or as a console of a head unit that is not indicated, etc. In particular, the console 110 has an HMI 113 and an NFC read device (or reader) 114, wherein the console is generally communicatively coupled or connected to the control apparatus 112 (i.e. data transmissions can be carried out in both directions). The HMI can include a display in particular, but also voice control, etc. The control apparatus can be, for example, part of access control of the vehicle 102, which is not indicated any further. In the vehicle 102, there is also a memory 116 assigned to the control apparatus 112. The memory 116 is intended to store fleet-related contents, as will be described below.

The backend 106 comprises specifically a backend 118 for key management and technical fleet management, which, for example, can be operated by a manufacturer of the vehicle 102, and a backend 120 of a fleet operator, wherein the vehicle 102 is part of a fleet of the fleet operator, as described below. The backend 118 is also referred to as the "manufacturer backend" 118 for short below, and the backend 120 is referred to as the "operator backend" 120. In addition, reference is sometimes made to the manufacturer 118 or the operator 120, meaning the vehicle manufacturer under whose responsibility the backend or the server 118 is operated, or the fleet operator who is responsible for operating the server 120.

In addition to the fleet management card, (FM) card or FMC ("Fleet Management Card") 104, there is another hardware token 122, for example in the form of a setup card or a key fob with a (vehicle) key for the vehicle 102. For the sake of clarity, reference is occasionally made to the (vehicle) key 122 for short below, meaning the key on the token 122. It should be noted, however, that the reference to the vehicle key on the hardware token 122 serves only to facilitate understanding. Constellations are contemplated in which no physical or hardware tokens are assigned to a vehicle any more and thus proof of ownership can only be provided via digital identities. In such a constellation, an employee would only have a digital key that can be used by the employee to drive a vehicle to a drop-off point. The employee would then, for example, confirm the removal from the fleet with a (his) fleet card and use the latter to also lock the vehicle.

The operating person 108 is, for example, an employee of the fleet operator 120, who handles both the fleet management card 104 and the console 110, i.e. for example performs operating actions on the console 110, calls up a menu, etc., holds the FM card 104 or the key card 122 to the reader 114 or places it on or in the latter, etc.

The FMC 104 acts as a carrier medium for a fleet ID 124 which, for example, identifies the fleet operator 120, but in a technical sense identifies, directly or by means of resolution (by interaction with the backend 118 and/or 120), a data set representing a fleet configuration 126 which, for example, when the vehicle 102 is integrated into the fleet, has been downloaded from the backend 106, stored in the memory 116 of the vehicle 102 and applied to the vehicle 102. The applied configuration 126 influences, for example, functions of the console 110 with the HMI 113 for customers of the fleet operator 120.

As schematically indicated in FIG. 1, the fleet configuration 126 (or a resulting fleet context in which the vehicle 102 is situated) partly comprises settings 127 that are accessible to users of the vehicle 102, such as a welcome menu in the HMI 113 for customers of the fleet operator 120.

However, the fleet configuration 126 generally also contains, e.g. on a corresponding separate data partition 128, a hidden or concealed fleet-related administrative menu 130 that is not accessible to the customers (or other, e.g. private, users). This menu 130 can be used, for example, to separate the vehicle 102 from the fleet or to carry out other critical operations.

Regarding the described division, it should generally be noted that the vehicle 102 is used by customers (e.g. of a vehicle rental company) or potential customers (e.g. in a showroom of a car dealership), and, for example, critical administrative maintenance menus or operations should not be accessible to these persons, even if the vehicle 102 is in a fleet context. More specifically, it should be ensured that only an authorized person, such as the employee 108, can make changes in the fleet context, i.e. Settings on the hidden menu 130 of the fleet configuration 126. This authorization can be proven by possession of the fleet management card 104, i.e. by the detectable presence of the card 104 on board the vehicle 102.

In previously known administrative methods, fleet-related management of the vehicle 102 was complicated if, for example, additional hardware components were required in the vehicle 102 and/or administration had to be carried out responsibly from the backend 106.

Exemplary embodiments according to the invention provide for the fleet management card or FMC 104 to be used not only for example to integrate the vehicle 102 into a fleet, but also and in particular for secure and/or convenient administrative handling of the vehicle 102 in a fleet context. As described hereinafter, the FMC 104 can be used on board the vehicle 102 and can additionally also be used outside the vehicle 102 for fleet-related administrative activities (relating to the vehicle 102) initiated by the backend 120.

It is advantageous if the FMC 104 is registered with the vehicle manufacturer or in the backend 118, e.g. so as to enable forwarding or interaction or communication (via the vehicle 102 and backend 118) with the server 120 of the fleet operator.

In the case of a fleet-related administrative activity, a management or maintenance action in the fleet context, etc. on board the vehicle 102, the employee 108 places the fleet management card 104 on the NFC read device 114. This enables or releases the protected data partition 128 with the hidden fleet configuration or the hidden menu 130; in particular, the menu 130 becomes accessible, for example on the HMI or display 113. The employee 108 can use the menu 130 to perform fleet-related interaction with the vehicle 102, i.e. the menu 130 offers at least one fleet-related setting option (indicated in FIG. 1 by a button 132). The setting, set or setting option can affect management, a management operation, action, act, handling, etc., a setting process, adaptation, a configuration action, etc.

The menu 130 preferably appears directly on a display of the HMI 113 or opens there when the card 104 is placed on the read device 114. Then the employee 108 can immediately perform a configuration action, make a change to the vehicle configuration, etc., specifically by selecting an option, changing a setting, etc., i.e. for example by pressing the button 132.

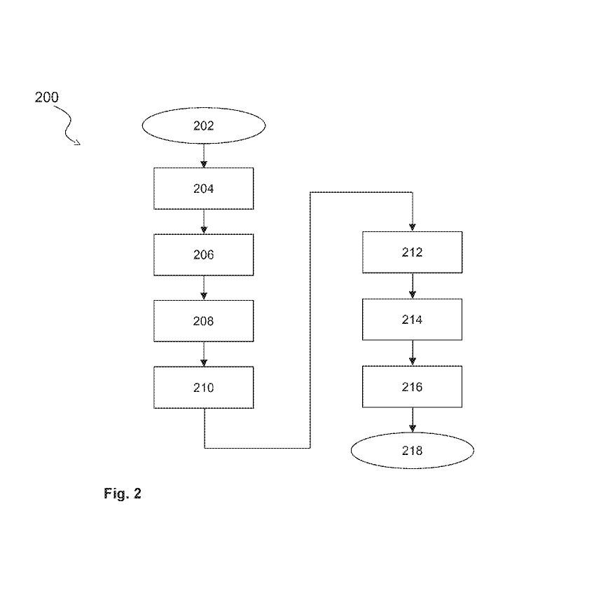

A specific example of secure, simple and convenient control of the motor vehicle 102 in a fleet context is described in more detail below with reference to the sequence schematically illustrated in FIG. 2. In this case, FIG. 2 shows the sequence of a corresponding method 200 in the control apparatus 112.

A sequence begins in a step 202 with the fact that the portable fleet management card 104 is detected in the motor vehicle 102, i.e. the (at least one) NFC read device 114 detects the FMC 104 in an interior of or on board the vehicle 102. In a step 204, the FMC 104 is verified. This can be carried out in various ways.

In one alternative, the fleet management card 104 is registered in the vehicle manufacturer backend 118. In this case, a handshake can take place between the FMC 104 and the vehicle manufacturer backend 118 (facilitated via the vehicle 102), in the course of which the backend 118 verifies the FMC 104 (and informs the vehicle 102 of the result of the verification).

In another alternative, the fleet management card 104 is known to the motor vehicle 102, for example because the fleet configuration 126 was applied to the vehicle 102 by means of a trust anchor, or because fleet management cards such as the card 104 are individually identifiable, for example, and the identity of the card 104 is stored in the vehicle 102.

In a step 206, in response to the verified presence of the fleet management card 104, at least one fleet-related setting for the motor vehicle 102 is enabled. In the schematic scenario in FIG. 1, the enabling comprises outputting the previously hidden menu 130 with the at least one interactive setting option 132 (button) for the motor vehicle 102.

More specifically, in a preferred exemplary embodiment, there are only a few possible ways to display the menu 130. The menu 130 is displayed, read out from data partition 128, etc., for example, only if an authorized fleet management card, in this case the FMC 104, is present in verified form, or if authorized verified access is made from the backend 104 (the latter is no longer of interest here). There is no way for people in the vehicle 102 to display the fleet-related menu 130 (and make settings via it) if the fleet management card 104 is not present in the vehicle 102.

The outputting of the menu 130 in step 206 can comprise, for example, the menu 130 being opened directly on the display 113 in order to enable the employee 108 to conveniently administer the fleet context of the vehicle 102.

In the exemplary embodiment illustrated in FIG. 2, the setting or the offered menu option comprises separating the motor vehicle 102 from the fleet of the fleet operator 120. It is assumed that the employee 108 selects this selection option in a step 208. For this option, which is to be regarded as critical, it is stipulated (e.g. in the data partition 128) that the selected option must be confirmed, and that the verified presence of the FMC 104 is required again for confirmation, i.e., in a step 210, the employee 108 must present the card 104 again, hold it to the card reader 114 or deposit it there etc. (if appropriate, it may be sufficient to leave the card 104 there, or the card 104 must be removed and deposited again, etc.), and the detected card 104 must be verified again (by the vehicle 102 or backend 118, as described above).

Since the option selected in step 208 is regarded as a critical option, a (vehicle) key for the motor vehicle 102 must also be detected and verified in a step 212. In the constellation in FIG. 1, the employee 108 presents the key card 122 to the read device 114, for example. Only after successful verification of the key on the card 122 can the option of separation from the fleet be performed or carried out or implemented.

In a step 214, the separation is implemented by applying a private configuration (instead of the fleet configuration 126) to the motor vehicle 102. The private, normal, regular or standard configuration may be intended for a private user, buyer, owner, proprietor etc. of the vehicle 102, i.e. if the vehicle 102 is configured, operated etc. as a private passenger vehicle.

In a step 216, the separation is further implemented by deleting at least all active digital keys for the motor vehicle 102 (i.e. all digital keys that still have authorizations for the vehicle 102).

In a step 218, the method 200 ends, for example, with the control apparatus 112 sending a notification to the backend 118 that the vehicle 102 is in a regular context. In another exemplary embodiment, the control apparatus 112 may send a request to the backend 118 to reconfigure the vehicle 102 in a private customer mode (and to adapt the backend configuration accordingly, i.e. for example separation from the current fleet, etc.).

Finally, the employee 108 locks the vehicle 102 with the setup card 122 (or the FMC 104).

It should be noted that the setting selected by the employee 108 in step 208 is implemented autonomously in the vehicle 102, i.e. without the need for another employee in the backend 118 or 120 to initiate the action, consent, approval etc. The described interactions with the backend 104 are only used to verify the FMC 104 or to resolve the fleet ID 124, if necessary. In other words, the fleet management card 104 can be used by the employee 108 on board the vehicle 102 to securely perform critical fleet-related management operations quickly, conveniently and in a simple manner. If the employee has a number of fleet vehicles to administer, the same fleet management card is sufficient, i.e. the employee or each employee only in principle needs such a card for the entire fleet of the fleet operator (for critical operations, the employee also needs a key for each vehicle, as suggested here).

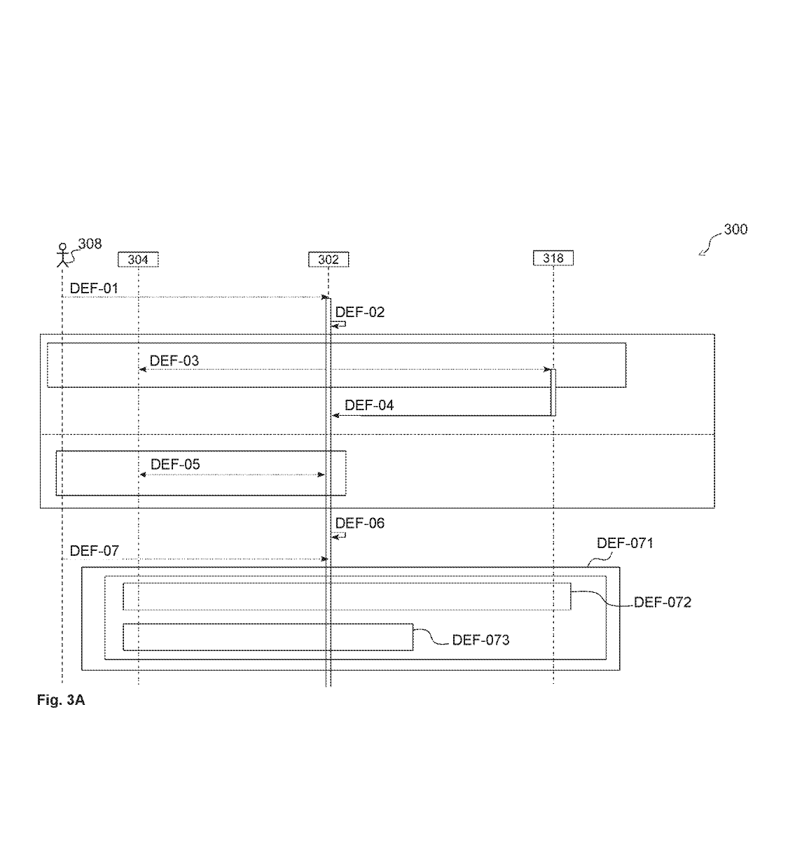

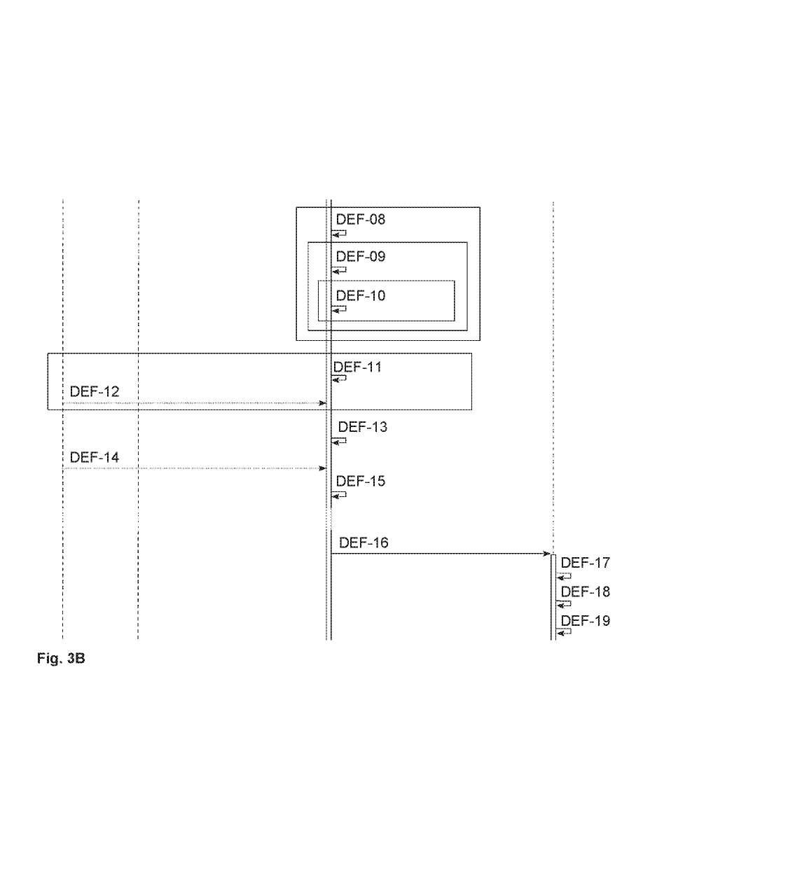

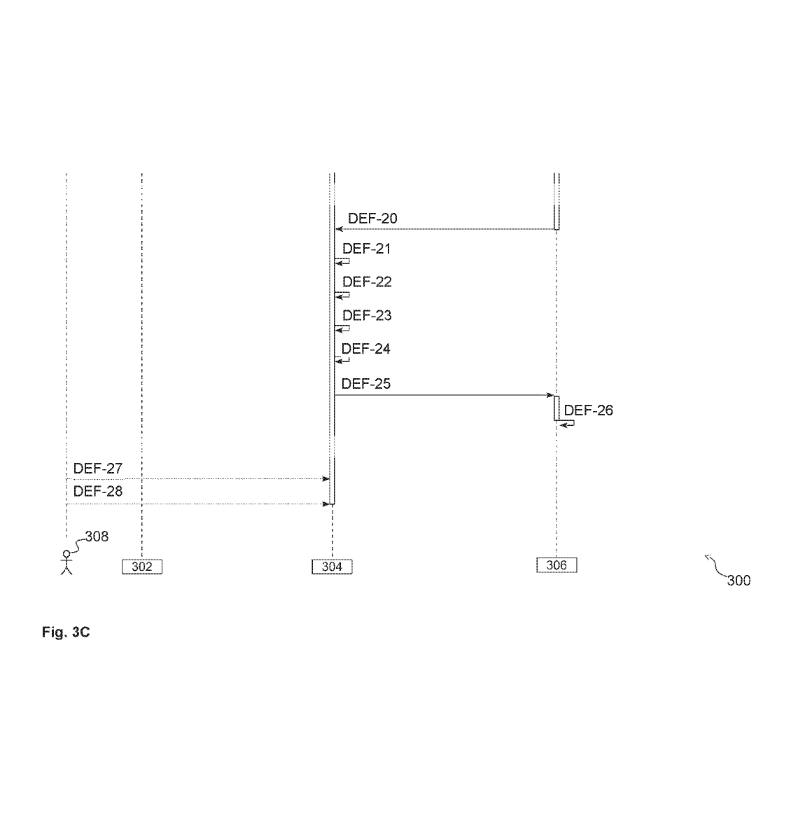

FIGS. 3A-3C illustrate, in the form of a schematic sequence diagram, another exemplary embodiment of a method 300 for administering a motor vehicle 302 by an employee 308 who handles a fleet management card 304. The method 300 involves a vehicle manufacturer backend 318 (manufacturer backend with key management and fleet management).

The motor vehicle 302, card 304, and backend 318 each represent an exemplary embodiment of the motor vehicle 102, the card 104 and the backend 118, respectively, described in relation to the constellation 100 in FIG. 1. The sequence 300 may also be an exemplary embodiment of the sequence 200 in FIG. 2. The statements made with regard to the employee 108 indicated in FIG. 1 apply to the employee 308.

At the beginning of method 300, the vehicle 302 is integrated into a fleet of a fleet operator and the corresponding fleet configuration is applied to the vehicle or in the vehicle 302. The method 300 relates to separation of the vehicle 302 from the vehicle fleet by means of the fleet management card 304 of the fleet operator. The fleet management card 304 is registered in the manufacturer backend 318. Additionally or alternatively, the fleet management card 304 may be known to the vehicle 302, as described elsewhere herein.

In an exemplary scenario, the employee 308 of a fleet provider takes the vehicle 302 to a handover location (e.g. a car dealership). So that the vehicle 302 can be used for a private customer, the fleet configuration in the vehicle 302 and in the backend 318 must be (re)set to a private vehicle configuration. The fleet management card 304 is used in the vehicle 302 to confirm the separation. This then (in interaction with the backend 318) results in the fleet configuration being deleted in the vehicle 302 and the private configuration being restored. All digital keys that are still active are deleted.

In the course of the method 300, the card 304 is held to or placed on an NFC read device in the vehicle 302. Optionally, the vehicle 302 checks a cryptographic key of the card 304. The vehicle 302 enables a fleet management menu in an HMI of the vehicle 302 (if necessary, the menu is displayed immediately in response to the placement of the card 304). The fleet employee 308 can select or initiate the separation of the vehicle 302 via the displayed menu. Optionally, before adopting the changed settings, the vehicle checks again for a presence of the fleet management card 304 (if the card is not placed on again, the menu can close by itself, for example after some time).

After confirmation, the backend 318 removes the vehicle 302 from the relevant fleet and composes a regular vehicle configuration (for private operation of the vehicle 302). The vehicle 302 performs the separation from the fleet by applying the regular vehicle configuration and deleting (e.g. permanently) all digital keys for the vehicle that are still active.

The reason for separating the vehicle 302 from the fleet, with the adoption of a regular configuration and deletion of the digital keys, is thus the (presence of the) FM card 304 in the vehicle 302, i.e. the reason does not originate from the backend 318.

In steps DEF-01 – DEF-15, the separation of the vehicle 302 is initiated in the vehicle 302 or initiated from on board the vehicle. In step DEF-01, the card 304 is brought into contact with a read device in the vehicle 302. In a step DEF-02, the vehicle 302 then checks a vehicle configuration (i.e. determines that a fleet configuration is present). Steps DEF-03 – DEF-04 relate to a first alternative progression in which the backend 318 is specifically triggered in relation to fleet management. In this case, step DEF-03 relates to a handshake between the card 304 and the backend 318, which is facilitated via the vehicle 302 and in the course of which the backend 318 verifies the FM card 304 and determines the relevant fleet operator. In step DEF-04, the backend 318 returns an identity or ID of the FM card and/or of an operator as well as and, if necessary, meta information to the vehicle 302.

In another alternative progression, represented by a step DEF-05, a fleet management-related interaction only takes place between the FM card 304 and the vehicle 302. Accordingly, in step DEF-05, a handshake is carried out between the card 304 and the vehicle 302. Here it is the vehicle 308 that verifies the FM card 304 and identifies the relevant fleet operator.

In a step DEF-06 following either steps DEF-03 – DEF-04 or step DEF-05, the vehicle 302 enables the relevant fleet management menu and also opens it immediately. In a step DEF-07, the employee 308 selects a displayed (i.e. selectable) menu item "Separation".

In response to the selection, a presence of the FM card 304 can first of all be optionally checked again (generally denoted DEF-071). Such a repetition can be required from a security point of view or from a process point of view. Technically, a handshake with the FM card 304 is performed again. Specifically, steps DEF-03 – DEF-04 are re-used for a first alternative progression (DEF-072), i.e. a handshake is performed between the card 304 and the backend 318 (facilitated via the vehicle 302). Step DEF-05 is re-used for another alternative progression (DEF-073), i.e. a handshake is performed between the FM card 304 and the vehicle 302.

Steps DEF-08 – DEF-10 concern a check to determine whether a vehicle key is present on board the vehicle 302. For this purpose, step DEF-08 checks whether such a presence is detected. Steps DEF-09 and DEF-10 concern the eventuality that this is not the case. In step DEF-09, the vehicle 302 outputs a pop-up stating that a valid key must be inside the vehicle in order to separate the vehicle 302 from the fleet (this can be displayed by name). Step DEF-10 checks for the presence of the key. Step DEF-10 is repeated in a loop until a key is detected or an abort occurs.

Steps DEF-11 and DEF-12 concern the fact that a presence of a setup card is required as an additional or alternative option. In step DEF-11, the vehicle 302 outputs a pop-up stating that a setup card must be placed on the NFC read device in order to separate the vehicle 302 from the fleet (this can be displayed by name). In step DEF-12, the employee 308 then brings a setup card in contact with the NFC reader as required.

After checking the key and/or setup card, the vehicle 302 in a step DEF-13 outputs a pop-up message stating that the operator is in the process of separating the vehicle and that all paired and shared digital keys are being deleted. It is queried whether the process should be continued. In a step DEF-14, the employee 308 confirms that the separation is to take place. The vehicle then sets a "separation - confirmed" mode or the like.

In steps DEF-16 – DEF-19, the vehicle 302 requests separation from the backend 318. In step DEF-16, the vehicle 302 sends a request for separation to the backend 318. For example, the request can include a fleet ID. In a step DEF-17, the backend 318 verifies the received request. In a step DEF-18, the backend 318 composes a regular configuration for the vehicle 302. In a step DEF-19, the backend 318 labels the vehicle 302 as "pending separation" or the like. This information can also be forwarded to the fleet operator if necessary (cf. server 120 in FIG. 1).

Steps DEF-20 - DEF-26 concern correcting and applying the regular configuration in the vehicle 302. In step DEF-20, backend 318 returns the regular configuration to the vehicle 302 in response to the request in step DEF-16. In a step DEF-21, the vehicle 302 checks whether it is in the "separation-confirmed" mode or context (see above). The regular configuration would be rejected if the application were not done in an explicit separation context (in particular because all shared or paired digital keys are deleted here).

In a step DEF-22, all paired or shared digital keys in the vehicle 302 are deleted. In a step DEF-23, the regular configuration is applied. In a step DEF-24, a pop-up stating that the vehicle has been separated from the fleet (which can be indicated by name) is output. In step DEF-25, the vehicle 302 confirms the separation to the vehicle backend 318. In a step DEF-26, the backend 318 removes the vehicle from the fleet (i.e. the SBOD is deleted). Corresponding information can also be passed on to the fleet operator.

In steps DEF-27 and DEF-28, the employee 308 leaves the vehicle 302. Specifically, the employee 308 gets out of the vehicle 302 in step DEF-27. In step DEF-28, the employee 308 locks the vehicle 302 with the setup card or key fob.

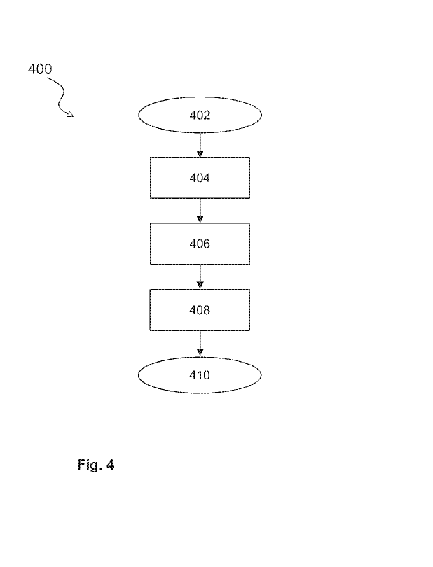

Another exemplary embodiment according to the invention for simple and convenient administration of the motor vehicle 102 in FIG. 1 in a fleet context is described in more detail below with reference to the sequence schematically illustrated in FIG. 4. The example in FIG. 4 relates to setting a presentation mode for the vehicle 102. For example, the mode can include various headlights, an ambient interior lighting system, the HMI 113 (e.g. presentation of a demo mode), etc.

In this respect, FIG. 4 shows the sequence of a corresponding method 400 in the control apparatus 112. Steps 402, 404 and 406 of the method 400 correspond to steps 202, 204 and 206 of the method 200. These have already been described further above. For reasons of clarity, a repetition is dispensed with and reference is made to the above statements.

In a step 408, the employee 108 selects a predefined presentation mode from a fleet-related menu displayed to him in response to the placement of the fleet management card 104, makes changes to the mode, etc. Selecting or setting a presentation mode for the vehicle 102 is not considered critical, and therefore steps such as step 210 in method 200, in which a presence of the fleet management card 104 is checked again or tested for, before adopting a (critical) setting, for confirmation, are omitted.

In particular, for adopting a non-critical setting, a step such as step 212, in which a presence of a vehicle key inside the vehicle 102 is checked, can also be omitted. Rather, for non-critical options, the one-time presence of the fleet management card 104 may be sufficient (namely to display the hidden menu 130).

Thus, in a step 410, the selected option is implemented, the selected or set presentation mode is activated, etc. and the method 400 is thus ended. It should be noted that the administrative setting chosen by the employee 108 is implemented autonomously in the motor vehicle 102, i.e. without the need for another employee in the backend 118 or 120 for initiation, consent, approval etc. An interaction with the backend 118 would serve only to verify the FMC 104 or to resolve the fleet ID 124, if necessary.

In other words, on board the vehicle 102, the employee 108 can only perform non-critical fleet-related management operations using the fleet management card 104 quickly, conveniently and in a simple yet secure manner. If the employee has a number of fleet vehicles to administer, the same fleet management card is sufficient, i.e. the employee or each employee only in principle needs such a card for the entire fleet of the fleet operator, and vehicle keys for each individual vehicle are not required.

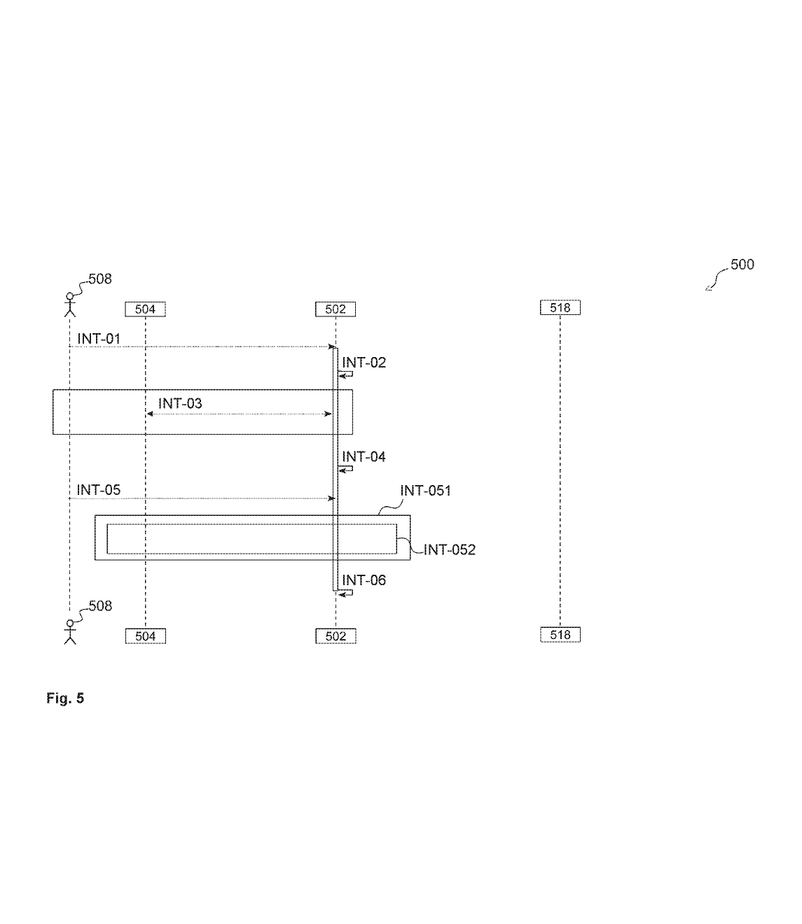

FIG. 5 illustrates, in the form of a schematic sequence diagram, another exemplary embodiment of a method 500 for administering a motor vehicle 502 by an employee 508 who handles a fleet management card 504. A (vehicle) manufacturer backend 518 is also shown.

The motor vehicle 502, card 504, and backend 518 each represent an exemplary embodiment of the motor vehicle 502, the card 504 and the backend 518, respectively, described in relation to the constellation 100 in FIG. 1. The sequence described below may also be an exemplary embodiment of the sequence 400 in FIG. 4. The statements made with regard to the employee 108 in FIG. 1 apply to the employee 508.

The method 500 illustrates an interaction of the vehicle 502 with the card 504 for adjusting or changing a vehicle setting regarded as non-critical (and handled accordingly in terms of the method or process), again in the example presentation parameters for presenting the vehicle 102 as an exhibition vehicle in a showroom of a car dealership or at a trade fair. This does not require the vehicle key 122 or a setup card for the vehicle 102. Thus, the employee 508 (only) needs the fleet management card 504 to display an otherwise hidden or concealed fleet-related administrative menu such as the menu 130. In other words, the exemplary method 500 illustrates how the fleet management card 504 can be used as a universal, sole or general "fleet key" for the vehicles in the corresponding fleet (in any case for appropriately released non-critical selection options).

The FM card 504 is advantageously known to the vehicle 502; e.g., the fleet configuration applied in the vehicle 502 can include an ID or other (identification) information relating to the card 504 that is suitable for identification (if necessary, IDs for multiple authorized cards may be stored in the vehicle, e.g. for multiple employees of the fleet operator). In this case, no interaction with the backend 518 is required, i.e. the vehicle 500 could be completely offline during the course of the method 500 (the backend 518 is shown in FIG. 5 only for the purposes of illustration and comparability).

In the method 500, the fleet management card 504 is first placed on an NFC read device in the vehicle 502. The vehicle 502 then unlocks a fleet management menu in an HMI. For example, the vehicle 502 can display the menu immediately. The employee 508 reconfigures the vehicle via the menu, e.g. sets showroom options. Optionally, the vehicle 502 can check a presence of the card 504 again before adopting the changed settings. If the card is no longer presented (or if there was no interaction with the displayed menu after the first presentation of the card 504), the menu can be closed automatically after some time.

Steps INT-01 – INT-06 in FIG. 5 specifically illustrate the performance of setting changes in the vehicle 500. In step INT-01, the employee 508 brings the FMC 504 into contact with an NFC reader in the vehicle 502. In step INT-02, the vehicle 502 checks a vehicle configuration: It is assumed that there is a fleet configuration, or a regular configuration with extensions that are accessible only when a fleet management card is present.

Step INT-03 relates to a handshake between the FM card 504 and the vehicle 502. The vehicle 502 verifies the FM card 504 and identifies the relevant fleet operator. In a step INT-04, the vehicle 502 makes the relevant fleet management menu available and preferably also displays it immediately.

In a step INT-05, the employee 508 makes changes, e.g. a change to a presentation mode for an exhibition vehicle. Before the changes are adopted, a presence of the FM card 504 can be optionally checked again (INT-051). Such a repetition can be required from a security point of view or from a process point of view. Technically, a handshake with the FM card 504 is performed again (INT-052), as described above.

In step INT-06, the changes are adopted, i.e. for example the set presentation mode for an exhibition vehicle with chosen options.

For further description, reference is made again to the constellation in FIG. 1 purely for illustrative reasons. In some exemplary embodiments of use according to the invention of the fleet management card 104, this can also be used outside the vehicle 102, for example in an office belonging to the employee 108, and can be used there for a fleet-related administrative activity, a corresponding management or maintenance action, etc. In one exemplary embodiment, the FMC 104 can be used for instance as a second factor for confirming critical operations.

For example, it is indicated in FIG. 1 that the FMC 104 has a digital certificate 134 which can be used, for example, for signature creation. In a specific exemplary embodiment of an interaction between the backend 118 of the vehicle manufacturer 118 and the backend of the fleet operator 120, the card 104 can be used for a challenge-response method in which the vehicle manufacturer 118 sends a challenge in response to a request for a critical action from the fleet operator 120. The card 104 is used to confirm the requested action or to check that the employee 108 is in possession of the card 104 and is therefore authorized to request the action. The card 104 returns the signed challenge.

An exemplary scenario involves confirming a turnaround process for a vehicle. A fleet operator initiates the turnaround process for the vehicle, which comprises, for example, cleaning and other maintenance of a vehicle returned by a customer, in order to provide the vehicle for the next customer. At a technical management or maintenance level, initiating the turnaround process may include a server call from the fleet operator to a system belonging to a vehicle manufacturer. In order to provide an additional level of security here, a fleet management card registered in the system belonging to the vehicle manufacturer (if appropriate for a specific fleet operator, or the card is tied to the fleet operator) can be used as a second factor to confirm the turnaround process and/or other actions that are regarded, marked, handled, etc. as critical, i.e. for example management actions (acts, operations, etc.) with high loss potential.

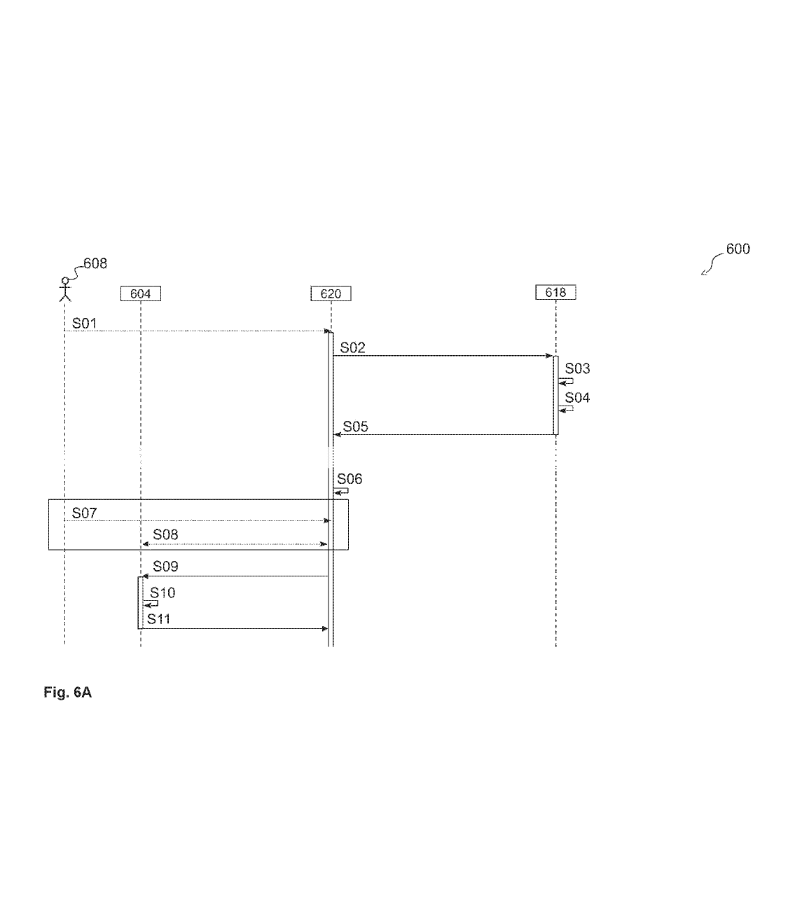

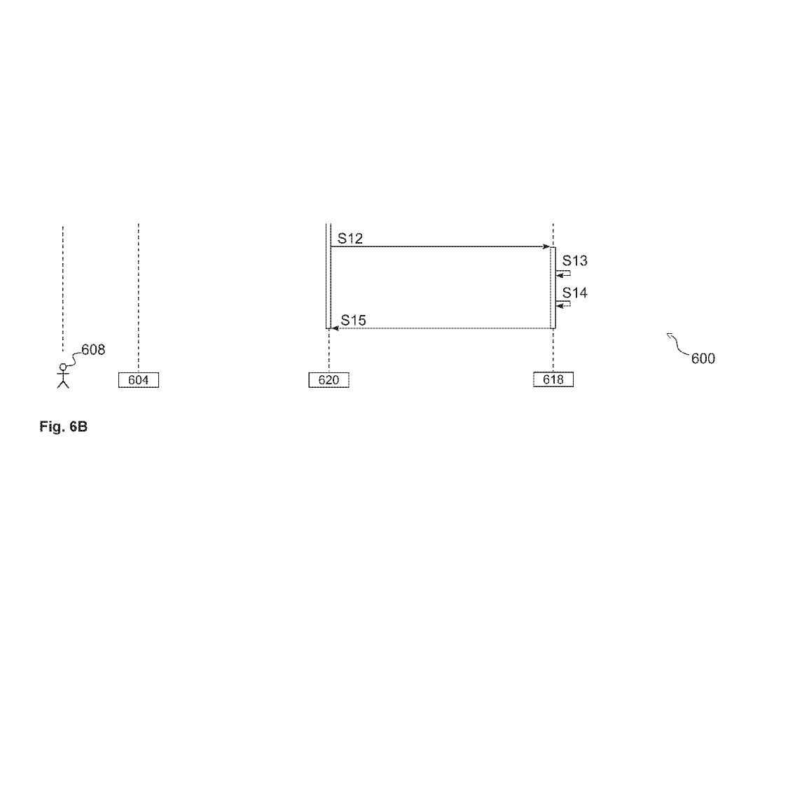

In this respect, FIGS. 6A-6B illustrate, in the form of a schematic sequence diagram, another exemplary embodiment of a method 600 for administering a motor vehicle by an employee 608 at a terminal (for example in an office belonging to a fleet operator) which is connected to a backend 620 of the fleet operator. The employee 608 handles a fleet management token or card 604. In addition, a manufacturer backend 618 is involved in the method.

The card 604, backend 618, and backend 620 each represent an exemplary embodiment of the card 104, backend 118 and backend 120, respectively, described in relation to the constellation 100 in FIG. 1. The statements made with regard to the employee 108 in FIG. 1 apply to the employee 608.

In addition, reference is occasionally made to the manufacturer 118, meaning the vehicle manufacturer under whose responsibility the backend or the server 118 is operated. If reference is made to the terminal 620 for short, this means the terminal belonging to the employee 608 that is connected to the backend 620.

In the course of the method 600, the employee 608 initiates a critical process. The backend 618 of the vehicle manufacturer requires a confirmation of this and provides the backend 620 of the fleet operator with one-time information ("nonce"). The employee 608 signs the one-time information with his fleet management card 604. The backend 618 of the vehicle manufacturer checks the signature and, if necessary, executes the critical process.

In this way, the fleet management card 604 can be used with little effort as a second factor, or the card 604 can be given a corresponding added value or additional benefit, e.g. if the employee 608 (and possibly further employees) has the same card 604 with him, in order to use it both on board the fleet vehicles and in the office for fleet-related management actions. Alternatively, the fleet operator can purchase a set of fleet management cards, some of which are used for administrative purposes on board the fleet vehicles and some for administrative purposes in the office.

Steps S01 – S05 concern initiation of the turnaround process considered critical. In step S01, the employee 608 initiates the turnaround process for a specific fleet vehicle at the terminal 620. In step S02, the terminal or the backend 620 sends a request to initiate the turnaround process for this vehicle to the manufacturer backend 618. For example, the request can include a VIN (VIN = Vehicle Identification Number).

In a step S03, the manufacturer backend 618 verifies the received request (the fleet management card 604 is registered with the vehicle manufacturer 618, as stated), thus checking, for example, whether the specified vehicle is assigned to the requesting fleet operator 620, whether the requested action is valid, etc. In a step S04, the manufacturer backend 618 generates one-time information for a confirmation. In a step S05, the manufacturer backend 618 returns the one-time information to the fleet operator 620.

Steps S06 - S15 concern a confirmation of the requested task. In step S06, the terminal or operator backend 620 checks whether the fleet management card 604 is present. Steps S07 – S08 concern the eventuality that this is not the case. In step S07, the employee 608 brings the card 604 into contact with a read device connected to or integrated into the terminal 620. In step S08, a handshake takes place between the terminal 620 and the fleet management card 604.

In a step S09, the terminal 620 sends a request to generate a signature to the fleet management card 604. The request contains the one-time information received from the manufacturer backend 618. In a step S10, the fleet management card 604 signs the one-time information. In a step S11, the fleet management card 604 returns the signed one-time information to the terminal 620.

In a step S12, the terminal 620 sends a renewed request to initiate the turnaround process for the particular vehicle to the manufacturer backend 618. The request contains the VIN and the signed one-time information as confirmation. In a step S13, the manufacturer backend 618 checks the received request and in particular verifies the signature. In the event of positive verification, the manufacturer backend 618 initiates the turnaround process for the fleet vehicle in a step S14. In a step S15, the manufacturer backend returns a corresponding execution confirmation to the operator backend 620

Embodiments of the invention provide concepts for administering, managing, handling, etc. fleet vehicles, which ensure both secure execution of management tasks, i.e. for example can prevent misuse, but also enable simple, intuitive, convenient and fast execution for the executing employees of the fleet operators.

For this purpose, it is proposed to use fleet management cards which the employee can carry with him and which can be used on board a fleet vehicle for fleet-related administrative tasks. When presented in the vehicle, the card can display an otherwise hidden administrative menu such that the employee can immediately perform his administrative tasks.

Here, security can be ensured again in a simple and intuitive way for critical tasks by asking the employee to provide a confirmation with his fleet management card and/or to present a vehicle key for the vehicle.

Embodiments according to the invention implement concepts in which the employee makes the settings or performs management actions autonomously in the vehicle, i.e. without the backend initiating the process or having to give consent. This leads to simple and clear processes. Processes which are not particularly critical can even take place without any interaction with the backend, i.e. when the vehicle is offline. In some constellations, the employee only needs his fleet management card, not a vehicle key, and can thus administer a number of fleet vehicles in a short time, for example at a trade fair or in a car dealership.

Certain embodiments of the fleet card also offer the employee a synergistic added value in that they can also be used outside the vehicle for fleet-related administrative tasks, e.g. as a second factor for multi-factor authentication, two-factor authentication, etc.

Embodiments according to the invention contribute to enabling fleet management in a general environment of digital key management or to making it representable and to facilitating it. Embodiments according to the invention generally increase the comfort and/or confidence in the usage or use of digital keys, and this is of great importance with regard to the increasing spread of digital vehicle keys.

Embodiments of the invention are of commercial interest to vehicle manufacturers, manufacturers of hardware tokens, etc., vehicle rental companies, as well as all tier 1 suppliers of digital keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
102 (Motor) vehicle
104 Fleet management card, (FM) card, FMC
106 General backend
108 (Operating) person, employee
110 Console
112 Control apparatus
113 HMI with display
114 NFC write/read device, reader
116 Memory for fleet management contents
118 Backend of the vehicle manufacturer, manufacturer backend
120 Backend of the fleet operator, operator backend
122 (Vehicle) key or key fob or key card
124 Fleet ID
126 Fleet configuration
127 Customer part
128 Completed data partition
130 Hidden administrative menu
132 Button
134 Digital certificate on the fleet management card
200 Method
202-218 Steps of the method
300 Method
302 (Motor) vehicle
304 Fleet management card, (FM) card, FMC
308 (Operating) person, employee
318 Manufacturer backend
DEF-01 - DEF-28 Steps of the method
400 Method
402-410 Steps of the method
500 Method
502 (Motor) vehicle
504 Fleet management card, (FM) card, FMC
508 (Operating) person, employee
518 Manufacturer backend
DEF-01 - DEF-06 Steps of the method
600 Method
604 Fleet management card, (FM) card, FMC
608 (Operating) person, employee
618 Manufacturer backend
620 Terminal or operator backend
S-01 – S-15 Steps of the method

What is claimed is:

1. A method for administering a motor vehicle in a fleet context, the method comprising the steps of:
detecting a portable fleet management token in the motor vehicle; and
enabling a fleet-related administrative setting in the motor vehicle in response to the detected presence of the fleet management token.

2. The method according to claim 1, wherein
the enabling comprises access to a menu with at least one interactive setting option for the motor vehicle.

3. The method according to claim 2, wherein the menu is opened immediately.

4. The method according to claim 1, wherein
the enabling is carried out in response to verification of the detected fleet management token.

5. The method according to claim 4, further comprising the step of:
in response to a selection of the fleet-related administrative setting, executing the selected setting in response to renewed verification of a presence of the fleet management token.

6. The method according to claim 1, further comprising the step of:
in response to a selection of the fleet-related administrative setting, verifying a presence of a vehicle key in the motor vehicle.

7. The method according to claim 5, wherein the fleet-related setting comprises separating the motor vehicle from a fleet.

8. The method according to claim 7, wherein the separation comprises applying a private configuration instead of a fleet configuration to the motor vehicle.

9. The method according to claim 6, wherein the fleet-related setting comprises separating the motor vehicle from a fleet.

10. The method according to claim 9, wherein the separation comprises applying a private configuration instead of a fleet configuration to the motor vehicle.

11. The method according to claim 7, wherein the separation comprises deleting digital keys for the motor vehicle.

12. The method according to claim 9, wherein the separation comprises deleting digital keys for the motor vehicle.

13. The method according to claim 1, wherein the setting is adjustable in an absence of a key for the motor vehicle.

14. The method according to claim 13, wherein the setting relates to a presentation mode of the motor vehicle.

15. Use of a portable hardware token as a fleet management token for administering a motor vehicle in a fleet context, wherein the fleet management token is configured to be detected in the motor vehicle, so that the motor vehicle, in response to the presence of the fleet management token, enables a fleet-related administrative setting in the motor vehicle.

16. The use according to claim 15, wherein the fleet management token is configured for use as a second factor for confirming a setting to a backend.

17. A control apparatus for administering a motor vehicle in a fleet context, he control apparatus comprising a processor and associated memory operatively configure to:
detect a portable fleet management token in the motor vehicle; and
enable a fleet-related administrative setting in the motor vehicle in response to the detected presence of the fleet management token.

18. A motor vehicle, comprising:
a read device designed to read at least one hardware token; and
a control apparatus according to claim 17.

19. A system, comprising:
a vehicle fleet comprising at least one motor vehicle according to claim 18; and
the hardware token configured for use as the fleet management token.
